(19) United States
(12) Patent Application Publication
(10) Pub. No.: US 2021/0277842 A1
(43) Pub. Date: Sep. 9, 2021

(54) COLD START OPERATION DEVICE FOR DIESEL ENGINE IN PLATEAU REGION AND CONTROL METHOD THEREOF

(71) Applicant: Tianjin University, Tianjin (CN)

(72) Inventors: Haifeng LIU, Tianjin (CN); Junsheng MA, Tianjin (CN); Guixiang MA, Tianjin (CN); Zihan HE, Tianjin (CN); Mingfa YAO, Tianjin (CN); Zunqing ZHENG, Tianjin (CN); Hu WANG, Tianjin (CN)

(73) Assignee: Tianjin University, Tianjin (CN)

(21) Appl. No.: 16/346,538

(22) PCT Filed: Mar. 29, 2018
(86) PCT No.: PCT/CN2018/081020

§ 371 Date: Apr. 30, 2019

(30) Foreign Application Priority Data
Mar. 14, 2018 (CN) 201810209576.7

(51) Int. Cl. F02D 41/06; F02D 41/00; F02N 19/04

(52) U.S. Cl. CPC F02D 41/064; F02D 41/0002; F02N 2200/122; F02D 2200/0414; F02D 2200/70; F02N 19/04

(57) ABSTRACT

The present invention discloses a cold start operation device and control method for a diesel engine in a plateau region under a low ambient temperature, allowing a starter to drive a piston to compress the low-temperature air, by using the heated air as the fresh inlet air to introduce it into the cylinder, so that the in-cylinder temperature at the compressing TDC is increased to obtain the ignition temperature, and finally achieving the cold start of diesel engines in plateau regions. The present invention avoids complicated preheating devices, and has simple structure and reliable performance, can achieve effective cold start in different low ambient temperature environments.

### FIELD OF THE INVENTION

The present invention relates to the technical field of internal combustion engines, and in particular to a cold start operation device and a control method for a diesel engine in a plateau region under a low ambient temperature.

### BACKGROUND OF THE INVENTION

On one hand, due to the low atmospheric pressure in the plateau region, the pressure of the compression top dead center (hereinafter referred to as TDC) of the diesel engine at the starting speed is much lower than that in the plain area. The pressure drop at the compression TDC causes the corresponding minimum ignition temperature to rise under this pressure, making it difficult to ignite. On the other hand, due to the low intake air temperature in the low ambient temperature environment in the alpine region, the compression TDC temperature of the diesel engine is lowered, further increasing the difficulty of ignition. In addition, under low temperature conditions, the increase of internal resistance of the battery and rapid increase in the starting current cause the terminal voltage of the battery and the starting output power to drop. And the lowered starting speed reduces the pressure and temperature of the compression TDC, further increasing the difficulty of cold starting of the diesel engine. A preheating device is better used to solve the problem of cold start of diesel engine in the alpine region, the intake preheating usually includes resistance wire heating, PTC heating device and flame preheater, etc. Although the intake heating has the advantages such as high reliability, easy to use and good starting effect, but also has the disadvantage of complicate structure, and may damage the glow plug by improper operation. Therefore, it is important to provide a method and a device to effectively solve the problem of cold start of diesel engines in plateau regions.

### SUMMARY OF THE INVENTION

The objective of the present invention is to overcome the defects of the prior art and to provide a cold start operation device and a control method for a diesel engine in a plateau region under a low ambient temperature. The device of the present invention has simple structure, reliable performance and can achieve effective cold start in different low ambient temperature environments.

A cold start operation device for a diesel engine in a plateau region under a low ambient temperature, including a thermal insulating chamber, an outlet provided on a side wall of the thermal insulating chamber is communicated with an air-inlet pipe of a cylinder via an outlet pipe, an inlet provided on another side wall of the thermal insulating chamber is communicated with an air-outlet pipe of the cylinder via an inlet pipe, an outlet control valve is arranged on the outlet of the thermal insulating chamber, and an inlet control valve is arranged on the inlet of the thermal insulating chamber; an inlet throttle valve is provided in the air-inlet pipe and arranged above the outlet of the outlet pipe, an outlet throttle valve is provided in the air-outlet pipe and arranged above the inlet of the inlet pipe, a first temperature sensor is arranged inside the thermal insulating chamber to measure the temperature inside the thermal insulating chamber, a second temperature sensor is installed at the outside of the engine to measure the ambient temperature; an ECU is connected to an inlet valve, an outlet valve, the inlet throttle valve, the outlet throttle valve, the inlet control valve, the outlet control valve, a cylinder injector, the first temperature sensor and the second temperature sensor by control lines, respectively; the ECU measures and obtains temperature information via the first temperature sensor and the second temperature sensor; each of the outlet pipe, the inlet pipe, and the thermal insulating chamber is provided with a heat insulating structure, respectively.

A cold start control method for a diesel engine in a plateau region under a low ambient temperature, including the following steps:

Step 1: when the engine starts, opening the inlet throttle valve, closing the outlet throttle valve, closing the outlet control valve, and opening the inlet control valve; allowing a starter to drive a cylinder piston to travel down, opening the inlet valve and closing the outlet valve, introducing the ambient low-temperature inlet air into the cylinder during the piston downstroke; and when the piston travels down to the bottom dead center (hereinafter referred to as BDC)at 20° CA, closing the inlet valve; allowing the piston to travel upwardly and compressing the inlet air by the piston to heat the temperature of the inlet air; and then the piston continuous moving upwardly to reach the TDC and then performing the downstroke, opening the outlet valve when the piston achieves the BDC; during the piston upstroke, emitting the heated inlet air in the cylinder to the thermal insulating chamber by passing through the air-inlet pipe and inlet pipe, due to the outlet throttle valve is closed; when the piston travels to the TDC, closing the inlet control valve and storing the compressed high-temperature inlet air into the thermal insulating chamber with thermal insulation function; meanwhile, measuring the current ambient temperature by the second temperature sensor, and obtaining the minimum inlet air temperature corresponding to the cold start temperature of the engine at the ambient temperature by internal calculation of the ECU;

Step 2: repeating the step 1 for a plurality of compressing and air inlet working cycles, when the measured temperature by the first temperature sensor in the thermal insulating chamber is higher than the minimum inlet air temperature corresponding to the cold start temperature of the engine, closing the inlet throttle valve, opening the outlet throttle valve, opening the outlet control valve, closing the inlet control valve; allowing the starter to drive the piston to travel down, opening the inlet valve, introducing the high-temperature air in the thermal insulating chamber into the cylinder during the piston downstroke; and when the piston travels down to the BDC at 20° CA, closing the inlet valve and closing the outlet control valve; allowing the piston to travel upwardly and compressing the high-temperature air to further heat the temperature thereof; injecting oil by the cylinder injector when the piston arrivies at the TDC; since the in-cylinder temperature at the TDC reaches the ignition temperature at this time, the engine can start successfully.

Compared with the prior art, the present invention has the following advantages:

Firstly, compared with the conventional inlet air preheating method, the present invention avoids complicated preheating devices, and has simple structure and reliable performance;

Secondly, the present invention can achieve effective cold start in different low ambient temperature environments.

### BRIEF DESCRIPTION OF THE DRAWINGS

FIG. 1 is a structure diagram of a cold start operation device for a diesel engine in a plateau region of the present invention.

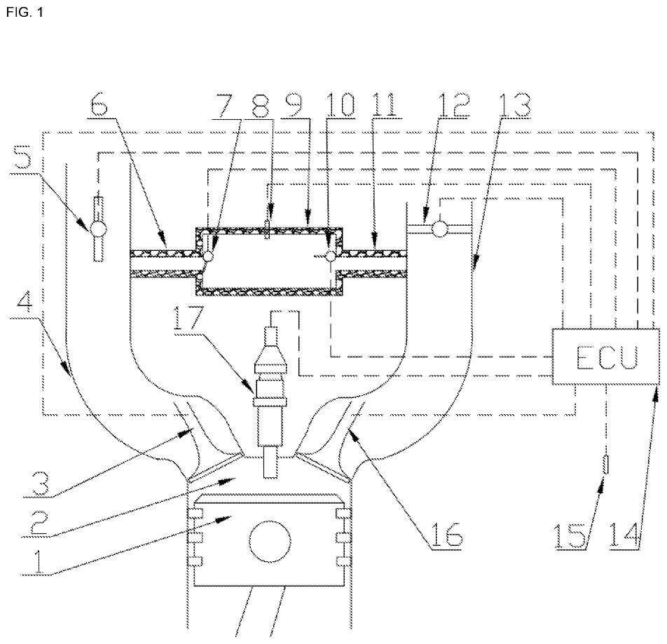

### DETAILED DESCRIPTION OF THE INVENTION WITH EMBODIMENTS

The technical solutions of the present invention will be further described below in detail by specific embodiments with reference to the accompanying drawings. The specific embodiments to be described are merely for explaining the present invention, rather than limiting the present invention.

A cold start operation device for a diesel engine in a plateau region under a low ambient temperature, including a thermal insulating chamber 9, an outlet provided on a side wall of the thermal insulating chamber 9 is communicated with an air-inlet pipe 4 of a cylinder via an outlet pipe 6, an inlet provided on another side wall of the thermal insulating chamber 9 is communicated with an air-outlet pipe 13 of the cylinder via an inlet pipe 11, an outlet control valve 7 is arranged on the outlet of the thermal insulating chamber 9, and an inlet control valve 10 is arranged on the inlet of the thermal insulating chamber 9.

An inlet throttle valve 5 is installed in the air-inlet pipe 4 and arranged above the outlet of the outlet pipe 6 (that is, arranged at upstream), an outlet throttle valve 12 is installed in the air-outlet pipe 13 and arranged above the inlet of the inlet pipe 11 that is, arranged at downstream), a first temperature sensor 8 is arranged inside the thermal insulating chamber 9 to measure the temperature inside the thermal insulating chamber 9, a second temperature sensor 15 is installed at the outside of the engine to measure the ambient temperature.

An ECU 14 is connected to an inlet valve 3, an outlet valve 16, the inlet throttle valve 5, the outlet throttle valve 12, the inlet control valve 10, the outlet control valve 7, a cylinder injector 17, the first temperature sensor 8 and the second temperature sensor 15 by control lines, respectively; the ECU 14 measures and obtains temperature information via the first temperature sensor 8 and the second temperature sensor 15.

Each of the outlet pipe 6, the inlet pipe 11 and the thermal insulating chamber 9 is insulated and provided with a heat insulating structure, respectively. The heat insulating structure can be found in the disclosed Chinese patent No. 201611223343.X and 201611031437.7.

A cold start control method for a diesel engine in a plateau region under a low ambient temperature, including the following steps:

Step 1: when the engine starts, opening the inlet throttle valve 5, closing the outlet throttle valve 12, closing the outlet control valve 7, and opening the inlet control valve 10; allowing a starter to drive a piston 1 of a cylinder 2 travelling down, opening the inlet valve 3 and closing the outlet valve 16, introducing the ambient low-temperature inlet air into the cylinder 2 during the downstroke of the piston 1; and when the piston 1 travels down to the BDC at 20° CA, closing the inlet valve 3; allowing the piston 1 to travel upwardly and compressing the inlet air by the piston 1 to heat the temperature of the inlet air; and then the piston 1 continuous moving upwardly to reach the TDC and then performing the downstroke, opening the outlet valve 16 when the piston 1 achieves the BDC; during the piston upstroke, emitting the heated inlet air in the cylinder 2 to the thermal insulating chamber 9 by passing through the air-inlet pipe 13 and inlet pipe 11, due to the outlet throttle valve 12 is closed; when the piston 1 travels to the TDC, closing the inlet control valve 10 and storing the compressed high-temperature inlet air into the thermal insulating chamber 9 with thermal insulation function; meanwhile, measuring the current ambient temperature by the second temperature sensor 15, and obtaining the minimum inlet air temperature corresponding to the cold start temperature of the engine at the ambient temperature by internal calculation of the ECU 14;

Step 2: repeating the step 1 for a plurality of compressing and air inlet working cycles, when the measured temperature by the first temperature sensor 8 in the thermal insulating chamber is higher than the minimum inlet air temperature corresponding to the cold start temperature of the engine, closing the inlet throttle valve 5, opening the outlet throttle valve 12, opening the outlet control valve 7, closing the inlet control valve 10; allowing the starter to drive the piston 1 to travel down, opening the inlet valve 3, introducing the high-temperature air in the thermal insulating chamber 9 into the cylinder 2 during the downstroke of the piston 1. When the piston 1 travels down to the BDC at 20° CA, closing the inlet valve 3 and closing the outlet control valve 7; allowing the piston 1 to travel upwardly and compressing the high-temperature air to further heat the temperature thereof; injecting oil by the cylinder injector 17 when the piston 1 arrives at the TDC. Since the in-cylinder temperature at the TDC reaches the ignition temperature at this time, the engine may be started successfully. After the engine is ignited, the control method is restored to the conventional control method.

Although the device and method of the present invention have been described above with reference to the accompanying drawings, the present invention is not limited thereto. The foregoing specific implementations are merely illustrative but not limiting. A person of ordinary skill in the art may make various forms under the teaching of the present invention without departing from the purpose of the present invention and the protection scope of the appended claims, and all the forms shall fall into the protection scope of the present invention.

What is claimed is:

1. A cold start operation device for a diesel engine in a plateau region under a low ambient temperature comprising:
a thermal insulating chamber; an outlet provided on a side wall of the thermal insulating chamber communicating with an air-inlet pipe of a cylinder via an outlet pipe, an inlet provided on another side wall of the thermal insulating chamber communicating with an air-outlet pipe of the cylinder via an inlet pipe;
an outlet control valve arranged on the outlet of the thermal insulating chamber;
an inlet control valve installed on the inlet of the thermal insulating chamber;
an inlet throttle valve installed in the air-inlet pipe and arranged above the outlet of the outlet pipe;
an outlet throttle valve installed in the air-outlet pipe and above the inlet of the inlet pipe;
a first temperature sensor installed inside the thermal insulating chamber to measure the temperature inside the thermal insulating chamber;
a second temperature sensor installed at the outside of the engine to measure the ambient temperature;
an ECU connecting to an inlet valve, an outlet valve, the inlet throttle valve, the outlet throttle valve, the inlet control valve, the outlet control valve, a cylinder injector, the first temperature sensor and the second temperature sensor by control lines, respectively; the ECU measuring and obtaining temperature information via the first temperature sensor and the second temperature sensor;
each of the outlet pipe, the inlet pipe, and the thermal insulating chamber provided with a heat insulating structure, respectively.

2. A cold start control method for a diesel engine in a plateau region under a low ambient temperature according to claim 1, including the following steps:
step 1: when the engine starts, opening the inlet throttle valve, closing the outlet throttle valve, closing the outlet control valve, and opening the inlet control valve; allowing a starter to drive a cylinder piston to travel down, opening the inlet valve and closing the outlet valve, introducing the ambient low-temperature inlet air into the cylinder during the piston downstroke; and
when the piston travels down to the bottom dead center (hereinafter referred to as BDC) at 20° CA, closing the inlet valve; allowing the piston to travel upwardly and compressing the inlet air by the piston to heat the temperature of the inlet air; and then the piston continuous moving upwardly to reach the TDC and then performing the downstroke, opening the outlet valve when the piston achieves the BDC; during the piston upstroke, emitting the heated inlet air in the cylinder to the thermal insulating chamber by passing through the air-inlet pipe and inlet pipe, due to the outlet throttle valve is closed; when the piston travels to the TDC, closing the inlet control valve and storing the compressed high-temperature inlet air into the thermal insulating chamber with thermal insulation function; meanwhile, measuring the current ambient temperature by the second temperature sensor, and obtaining the minimum inlet air temperature corresponding to the cold start temperature of the engine at the ambient temperature by internal calculation of the ECU;
step 2: repeating the step 1 for a plurality of compressing and air inlet working cycles, when the measured temperature by the first temperature sensor in the thermal insulating chamber is higher than the minimum inlet air temperature corresponding to the cold start temperature of the engine, closing the inlet throttle valve, opening the outlet throttle valve, opening the outlet control valve, closing the inlet control valve; allowing the starter to drive the piston to travel down, opening the inlet valve, introducing the high-temperature air in the thermal insulating chamber into the cylinder during the piston downstroke; and when the piston travels down to the BDC at 20° CA, closing the inlet valve and closing the outlet control valve; allowing the piston to travel upwardly and compressing the high-temperature air to further heat the temperature thereof; injecting oil by the cylinder injector when the piston arrivies at the TDC; since the in-cylinder temperature at the TDC reaches the ignition temperature at this time, the engine starts successfully.
